(19) United States
(12) Patent Application Publication
(10) Pub. No.: US 2009/0097074 A1
(43) Pub. Date: Apr. 16, 2009

(54) IMAGE PROCESSING APPARATUS AND METHOD THEREOF

(75) Inventor: Naoto Kawamura, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/247,050

(22) Filed: Oct. 7, 2008

(30) Foreign Application Priority Data
Oct. 16, 2007 (JP) 2007-269531

(51) Int. Cl. H04N 1/405

(52) U.S. Cl. 358/3.13

(57) ABSTRACT

Appropriate halftone processing is applied to respective regions without any zone segmentation of a document image formed upon mixing a photographic image, character image/line drawing, and the like. Hence, an image is input, an edge image of the image is generated, a smoothed image of the edge image is generated by smoothing processing, and lattice points having a density distribution according to the tone density distribution of the smoothed image are set. A predetermined region is partitioned into polygons, each of which surrounds one of the lattice points, and a threshold matrix used to grow a halftone dot surrounded by each polygon is generated.

### BACKGROUND OF THE INVENTION

1. Field of the Invention

The present invention relates to halftone processing.

2. Description of the Related Art

Electrophotographic printing apparatuses are prevalently put to practical use as copying machines, multi-functional peripheral equipments (MFPs), and printers for office use. These printing apparatuses normally handle so-called document images generated upon mixing various kinds of images such as a photographic image of continuous tone, a character image/line drawing such as characters, line arts, and the like, graphics such as graphs, computer graphics (CG), and the like.

Of these images, a photographic image and character image/line drawing have greatly differing feature amounts. A photographic image needs to be printed by stressing tonality, while a character image/line drawing needs to be printed by stressing the resolution. For this reason, image processing for printing a photographic image with high image quality is different from that for printing a character image/line drawing with high image quality. That is, halftone processing using a halftone dot screen or line screen is applied to a photographic image. When this halftone processing is applied to a character image/line drawing, an edge of the character image/line drawing is expressed by halftone dots, resulting in a considerable drop in print quality.

In order to avoid the aforementioned problem, zone segmentation for segmenting a document image into a region of a photographic image (to be referred to as a photographic region hereinafter) and that of a character image/line drawing (to be referred to as a text region hereinafter) is executed. Then, printing is done based on a dither method or tone density pattern method using a halftone screen for a photographic image (to be referred to as a photographic screen hereinafter) on the photographic region, and a screen for a character image/line drawing (to be referred to as a text screen hereinafter) on the text region. For the photographic screen, a threshold matrix of a relatively large size is used to obtain the sufficient number of tones. On the other hand, for the text screen, a threshold matrix of a small size or a fixed threshold is used. With this processing, a document image obtained upon mixing images of different features can be printed with high image quality.

However, zone segmentation of a document image suffers the following problems, requires a complicated algorithm, and is used only in expensive printing apparatuses.

(1) Zone segmentation requires an input memory used to store an image, and an output memory used to store the zone segmentation result, resulting in a large hardware scale and an increase in the cost of the apparatus.

(2) Improvement of segmentation precision leads to a complicated segmentation algorithm, resulting in a further increase in cost and a drop in processing performance.

(3) When a photographic image and character image/line drawing intricately overlap each other or when halftone characters are included, zone segmentation is often difficult to attain. If such regions are included, image quality deterioration (artifact) occurs, thus considerably lowering image quality.

Therefore, a method of printing a document image with high image quality without zone segmentation is demanded. As one method, a method using a halftone screen of a high screen ruling may be used. For example, upon execution of dither processing using a halftone screen of 300 lines or more, the sharpness of the edge of a character image/line drawing is improved. However, the tonality of a photographic image considerably deteriorates. In particular, an electrophotographic printing apparatus becomes harder to reproduce tones with increasing screen ruling. Hence, upon stressing printing of a photographic image, this method cannot used.

### SUMMARY OF THE INVENTION

In one aspect, an image processing apparatus comprising: an input section, arranged to input an image; a first generator, arranged to generate an edge image of the image; a smoothing section, arranged to generate a smoothed image by applying smoothing processing to the edge image; a setting section, arranged to set lattice points having a density distribution according to a tone density distribution of the smoothed image; a partition section, arranged to partition a predetermined region into polygons each of which surrounds one of the lattice points; and a second generator, arranged to generate a threshold matrix used to grow a halftone dot surrounded by each polygon.

According to the aspect, appropriate halftone processing can be applied to respective regions without zone segmentation of a document image formed upon mixing a photographic image, character image/line drawing, and the like. Also, appropriate halftone processing can be applied to respective regions of an image in which a photographic image and character image/line drawing intricately overlap each other, a halftone character image/line drawing, and the like, which cannot undergo zone segmentation.

Further features of the present invention will become apparent from the following description of exemplary embodiments with reference to the attached drawings.

### BRIEF DESCRIPTION OF THE DRAWINGS

FIG. 1 is a block diagram showing the arrangement of an image processing apparatus according to an embodiment;

FIG. 2 is a view showing the arrangement of an optical system of a printer;

FIG. 3 is a block diagram showing the arrangement of a dot generator which generates a halftone screen, the density of which is variable;

FIG. 4 is a flowchart for explaining halftone processing using a VDS;

FIG. 5 is a view showing an example of an input image used to explain generation of an edge image;

FIG. 6 is a view showing a Laplacian filter;

FIG. 7 is a view showing an example of an edge image;

FIG. 8 is a view showing a smoothing filter;

FIG. 9 is a view showing an example of a smoothed image;

FIG. 10 is a view showing a setting example of lattice points having a density distribution proportional to the tone density distribution of a smoothed image;

FIG. 11 is a view showing kernel points of Voronoi polygons obtained by repeating CVT three times;

FIG. 12 is a view showing Voronoi polygons;

FIG. 13 is a flowchart showing halftone processing for growing halftone dots to have Voronoi polygons as halftone-dot shapes;

FIG. 14 is a view showing a state in which the centroidal positions of respective Voronoi polygons and an image overlap each other;

FIG. 15 is a view showing an example of a halftone image;

FIG. 16 is a view showing an example of a threshold matrix;

FIG. 17 is a flowchart for explaining introduction of lattice points at a density proportional to the tone density of a smoothed image;

FIG. 18 is a view showing the number and positions of lattice points introduced to a block according to an edge magnitude Eq;

FIGS. 19A to 21B are views showing a state in which Voronoi partition is executed to have lattice points as kernel points and CVT is repeated;

FIG. 22 is a view showing an example of a small character image drawn on a gray background;

FIG. 23 is a view showing an edge image of the character image shown in FIG. 22;

FIG. 24 is a view showing a smoothed image of the edge image shown in FIG. 23;

FIG. 25 is a view showing a state in which lattice points are introduced according to the tone densities of the smoothed image;

FIG. 26 is a view showing a state in which the lattice points are extracted from FIG. 25;

FIGS. 27A to 27C are views showing Voronoi partition using the lattice points in FIG. 26 as kernel points;

FIGS. 28A and 28B are views showing the second CVT result;

FIG. 29 is a view illustrating the final lattice points and Voronoi polygons to overlap each other;

FIG. 30 is a view showing a halftone image obtained by filling regions of Voronoi polygons in FIG. 29 according to the tone densities;

FIG. 31 is a view for explaining rendering for respective bands;

FIG. 32 is a view showing a band image;

FIG. 33 is a view showing a method of forming Delaunay triangles;

FIGS. 34A to 34D are views showing changes of Delaunay triangles when a lattice point Px is set in the next band image;

FIG. 35 is a view for explaining halftone processing for respective bands, which permits changes of Voronoi polygons; and

FIG. 36 is a flowchart showing processing of band images.

### DESCRIPTION OF THE EMBODIMENTS

Image processing according to embodiments of the present invention will be described in detail hereinafter with reference to the accompanying drawings.

### First Embodiment

[Apparatus Arrangement]

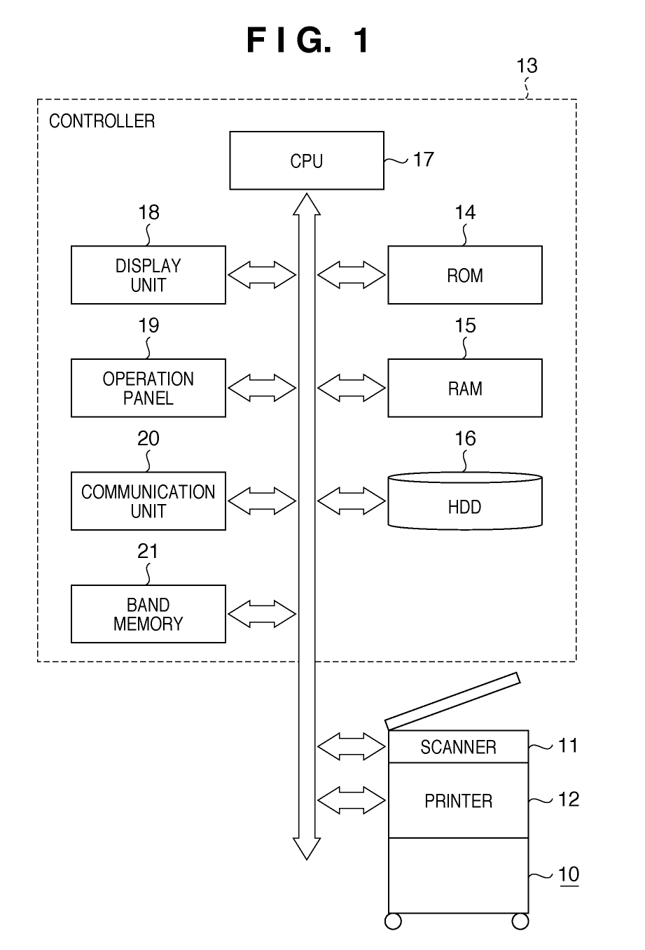

FIG. 1 is a block diagram showing the arrangement of an image processing apparatus according to an embodiment.

Functions of an MFP 10, which has a scanner 11 and an electrophotographic printer 12, are controlled by a controller 13 incorporated in the MFP 10.

A microcontroller (CPU) 17 of the controller 13 executes an operating system (OS) and various programs stored in a read only memory (ROM) 14 and hard disk drive (HDD) 16 using a random access memory (RAM) 15 as a work memory. The HDD 16 stores programs such as a control program, image processing program, and the like, and image data. A band memory 21 is a memory for halftone processing (to be described later). Note that the band memory 21 may be allocated on the RAM 15 or may be provided independently of the RAM 15.

The CPU 17 displays a user interface on a display unit 18 and inputs user's instructions from software keys on the display unit 18 and a keyboard of an operation panel 19. For example, when a user's instruction indicates a copy instruction, the CPU 17 controls the printer 12 to print a document image scanned by the scanner 11 (copy function).

A communication unit 20 is a communication interface which is connected to a public line and computer network (although not shown). When a user's instruction indicates a facsimile sending instruction, the CPU 17 controls the communication unit 20 to send a document image scanned by the scanner 11 to a communication partner designated by the user as a facsimile image (facsimile function). When a user's instruction indicates a push scan instruction, the CPU 17 controls the communication unit 20 to send a document image scanned by the scanner 11 to a designated server (push scan function). When the communication unit 20 receives a facsimile image, the CPU 17 controls the printer 12 to print the received image (facsimile function). When the communication unit 20 receives a print job, the CPU 17 controls the printer 12 to print an image in accordance with the print job (printer function). When the communication unit 20 receives a pull scan job, the CPU 17 sends a document image scanned by the scanner 11 to a designated server or client in accordance with the scan job (pull scan function).

Arrangement of Optical System

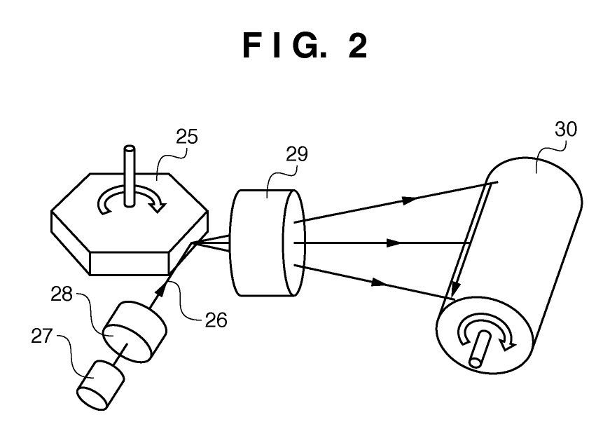

FIG. 2 is a view showing the arrangement of an optical system of the printer 12.

A light beam 26 emitted by a light source 27 such as a semiconductor laser element or the like enters a reflecting surface of a rotary polygonal mirror 25 via a collimator lens 28 based on a spherical system or anamorphic optical system. The light beam 26 deflected by rotation of the rotary polygonal mirror 25 is imaged on a rotating photosensitive drum 30 via an imaging lens 29 such as an f-θ lens or the like, thus optically scanning the surface of the photosensitive drum 30.

Dot Generator

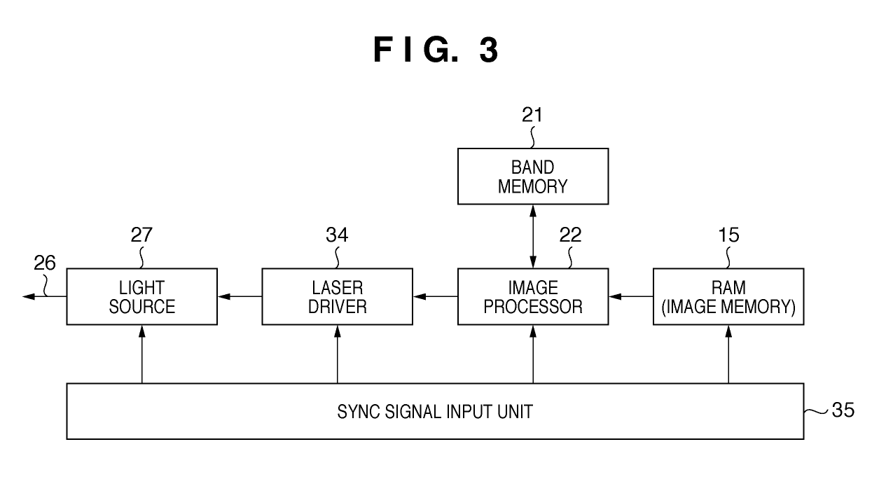

FIG. 3 is a block diagram showing the arrangement of a dot generator which generates a halftone screen, the density of which is variable. Note that the dot generator is configured as a part of the controller 13. In the following description, the halftone screen, the density of which is variable, will be referred to as a “variable density-halftone screen” (VDS).

A sync signal input unit 35 inputs, as synchronizing signals, a horizontal synchronizing signal Hsync indicating the scan timing of one line, vertical synchronizing signal Vsync indicating the scan timing of one page, and pixel clocks Vclock from the printer 12. These synchronizing signals are supplied to the RAM 15, an image processor 22, a laser driver 34, and a light source 27, so as to control image formation timings.

The image processor 22 sequentially receives images for respective bands (band images) from an image memory allocated on the RAM 15 using the band memory 21, and executes rendering including halftone processing using a VDS (to be described later) for respective band images. The laser driver 34 drives the light source 27 in accordance with a binary signal output from the image processor 22, thus controlling light emission of the light source 27.

[Halftone Processing Using VDS]

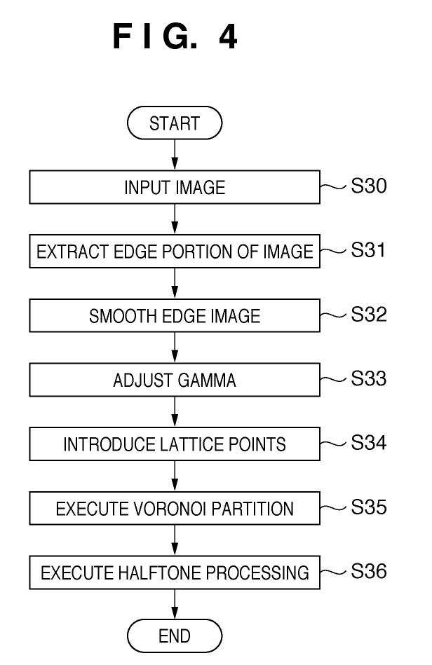

FIG. 4 is a flowchart for explaining halftone processing using a VDS. The image processor 22 executes this processing.

The image processor 22 receives image data from the band memory 21 (S30), and generates an edge image by extracting an edge portion of an image (S31). The image processor 22 applies smoothing processing to the edge image to generate a smoothed image (S32), and corrects the tone density of the image by gamma adjustment as needed (S33).

The image processor 22 introduces lattice points having a density distribution according to the tone density distribution of the smoothed image (the distribution of edge magnitudes) (S34), and creates Voronoi polygons by executing Voronoi partition to have the lattice points as kernel points (S35). Then, the image processor 22 executes halftone processing for growing each halftone dot to have a Voronoi polygon as a halftone-dot shape (S36).

Generation of Edge Image (S31)

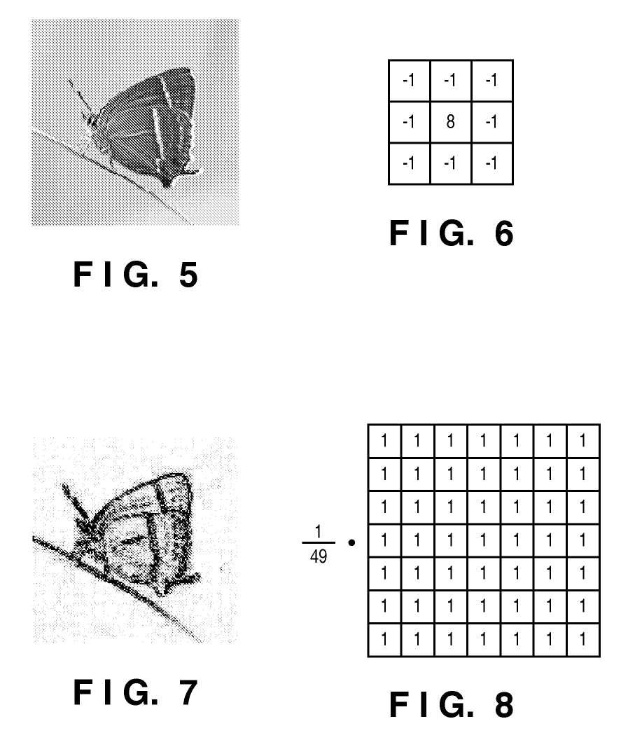

FIG. 5 is a view showing an example of an input image used to explain generation of an edge image.

The image processor 22 extracts an edge portion of an input image using an edge extraction filter. The edge extraction filter includes many filters such as a Laplacian filter, Canny filter, and the like, and a filter which has no directional dependence and does not pick up any noise is desirable. In this embodiment, the image processor 22 generates an edge image of the input image to have the absolute values of the filter processing results as edge components using a Laplacian filter as a secondary derivative filter shown in FIG. 6.

Generation of Smoothed Image (S32)

FIG. 7 is a view showing an example of an edge image generated from the input image.

The image processor 22 generates a smoothed image by smoothing an edge image shown in FIG. 7. The purpose of smoothing is as follows. That is, when the density of a halftone-dot lattice is modulated in proportion to the edge magnitudes, a moderate change in density gives a good effect to image quality rather than an abrupt change in density.

As a smoothing filter, a 7×7 smoothing filter shown in, for example, FIG. 8, may be used. In order to further enhance a smoothing effect, a smoothing filter having a larger size is used or smoothing is done a plurality of times using a smoothing filter of a small size. In this embodiment, a filter given by the following equation is used as a 2m−1 square Gaussian filter. In order to enhance the smoothing effect, for example, m=8 and a=6 to form a 15×15 smoothing filter.

Filter[i, j]=exp {[−(i−m)²−(j−m)²]/a²} (1)

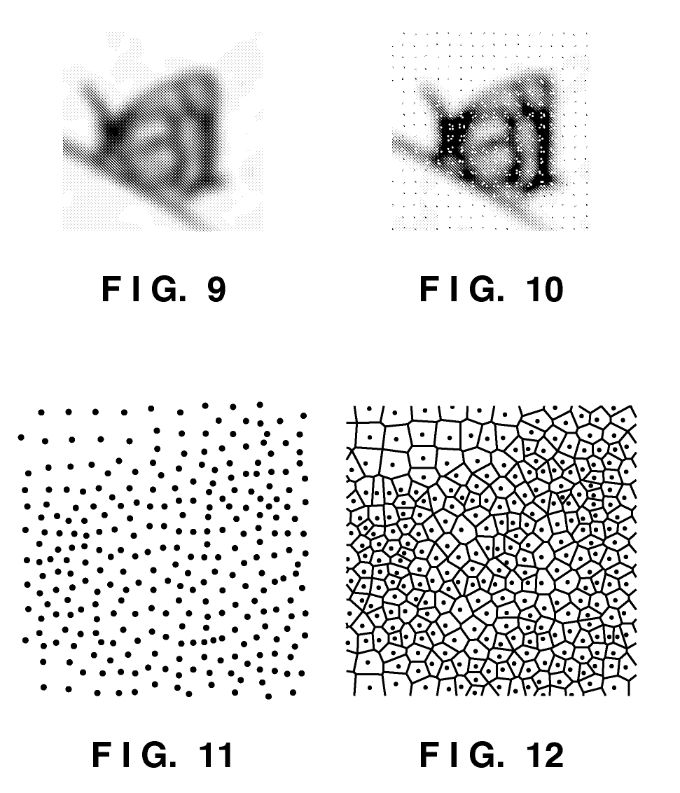

FIG. 9 is a view showing an example of a smoothed image generated by smoothing the edge image.

Since an image after smoothing suffers an increase in luminance (a decrease in tone density), the gamma characteristic of the image is appropriately adjusted so that a maximum value of the tone densities of the smoothed image falls within a given range, thus suppressing the decrease in tone density (S33). The lower limit of the above range assumes a predetermined value so as to give a predetermined halftone-dot density. By controlling this lower limit value, image quality can also be controlled, and that lower limit value can be used as an image quality adjustment parameter.

Introduction of Lattice Points (S34)

The image processor 22 introduces lattice points having a density distribution proportional to the tone density distribution of the smoothed image. That is, the image processor 22 assigns a larger number of lattice points to a high tone density portion of the smoothed image (an edge portion of the image) to increase a halftone-dot density. The image processor 22 assigns lattice points to a low tone density portion (a flat portion of the image) so that the halftone-dot density becomes a predetermined density (a halftone-dot ruling determined to some extent). In the following description, the setting of the halftone-dot density according to the tone density of an image will often be referred to as “density modulation”. The centers of halftone dots are lattice points of a halftone-dot lattice, and by setting the density of the lattice points to be high, the halftone-dot density can be increased (in other words, a dot sequence with a high halftone-dot ruling is obtained), thus allowing a minute description.

FIG. 10 is a view showing a setting example of lattice points.

Details of the introduction method of lattice points will be described later. As shown in FIG. 10, lattice points introduced in this stage suffer a problem, i.e., lattice points of a high density portion are too close to each other. This problem is solved by centroidal Voronoi tessellation (CVT; to be described later). FIG. 11 is a view showing kernel points of Voronoi polygons obtained by repeating the CVT three times. By setting these kernel points as lattice points, the problem in FIG. 10 (i.e., lattice points of a high density portion are too close to each other) is solved.

Voronoi Partition

The image processor 22 forms Voronoi polygons having lattice points shown in FIG. 11 as kernel points. A Voronoi polygon with respect to a lattice point Pi is a set of points V(Pi) given by:

V(Pi)={P|d(P, Pi)<d(P, Pj), ∀j≠i} (2)

where Pj is a dot-lattice point adjacent to Pi,

d(P, Pi) is the distance between a point P and the dot-lattice point Pi, and

d(P, Pj) is the distance between the point P and dot-lattice point Pj.

The Voronoi polygon represents an influential zone of the dot-lattice point Pi.

Each side (Voronoi boundary) of the Voronoi polygon is a line segment that couples the circumcenters of Delaunay triangles. The Delaunay triangle has, as sides, line segments that couple adjacent dot-lattice points, and is uniquely determined with respect to the dot-lattice point. Therefore, the Voronoi polygon is also uniquely determined. The circumcenter (Gx, Gy) of the Delaunay triangle is expressed by:

Gx={X0²(Y1−Y2)+X1²(Y2−Y0)+X2²(Y0−Y1)−(Y0−Y1)(Y1−Y2)(Y2−Y0)}/L

Gy=−Gx(X2−X1)/(Y2−Y1)+(X2−X1)(X1+X2)/2/(Y2−Y1)+(Y1+Y2)/2 (3)

for L=2{X0(Y1−Y2)+X1(Y2−Y0)+X2(Y0−Y1)}

where (X0, Y0), (X1, Y1), and (X2, Y2) are the coordinates of vertices of the Delaunay triangle.

In this way, a Voronoi polygon including one dot-lattice point is formed, and that Voronoi polygon is used to define a halftone-dot shape. FIG. 12 is a view showing Voronoi polygons (halftone-dot shapes), and these Voronoi polygons serve as growing regions of halftone dots. The Voronoi polygons determine visually smooth halftone-dot shapes with respect to lattice points which are randomly laid out. If density modulation is to be executed using a square dot lattice by varying a halftone dot area, the interior of each halftone dot cannot be filled up well (to grow a black dot). When Voronoi polygons are used, the interior of each halftone dot can be filled up visually naturally.

Halftone Processing (S36)

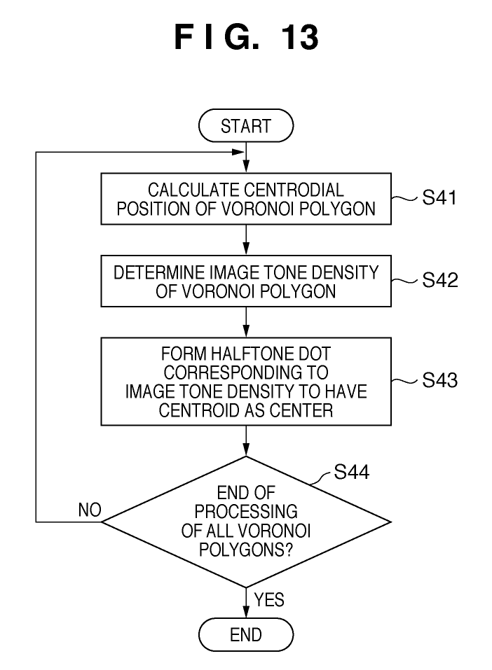

FIG. 13 is a flowchart showing halftone processing for growing halftone dots to have Voronoi polygons as halftone-dot shapes.

The image processor 22 calculates the centroidal positions of the Voronoi polygons shown in FIG. 12 (S41). As will be described in detail later, since the CVT has been repeated several times so far, the centroids and lattice points are located at nearly the same positions. Therefore, no problem is posed if the lattice points (kernel points) included in the Voronoi polygons are used intact as the centroids.

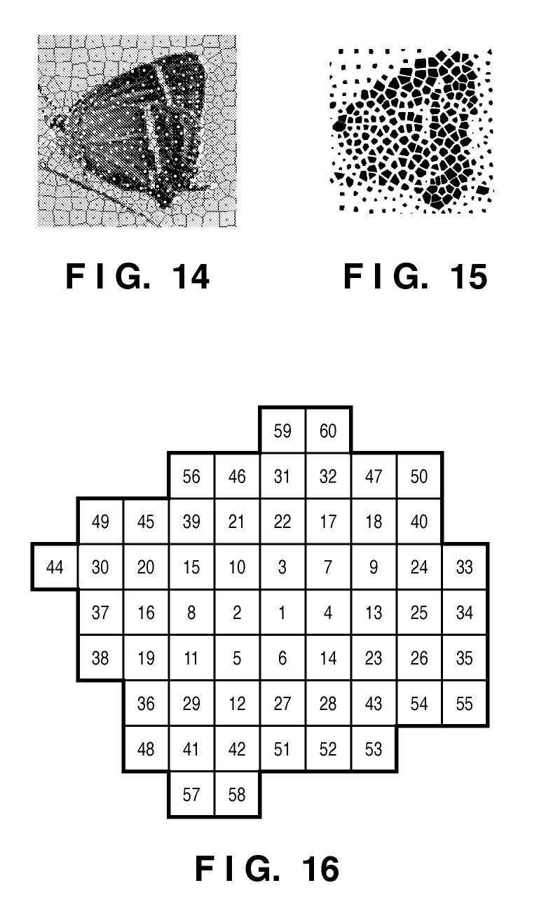

The image processor 22 determines the image tone densities of the respective Voronoi polygons (S42). FIG. 14 is a view showing a state in which the centroidal positions (indicated by dots) of the respective Voronoi polygons and an image overlap each other. The tone densities of the Voronoi polygons are represented by the image tone densities at the centroidal positions, or are determined to be the average tone densities of images in the Voronoi polygons.

The image processor 22 then grows halftone dots in accordance with the image tone densities of the Voronoi polygons to have the centroids as the central points of the halftone dots (S43). That is, using, for example, a tone density pattern method, a halftone image is generated by filling the interiors of the Voronoi polygons to have the centroids as the centers in accordance with the image tone densities of the Voronoi polygons.

Various methods of growing halftone dots are available. For example, a region, which has an area proportional to the tone density and is nearly similar to a Voronoi polygon, may be filled. That is, when the tone density is 100% (255 in case of 8-bit data), the interior of a Voronoi polygon is fully filled; when the tone density is 0%, filling is skipped. In case of a middle tone density A %, a region, which has an area corresponding to A % and is nearly similar to a Voronoi polygon, is filled. Filling is done for respective dots (e.g., minimum dots) that the printer 12 can record.

FIG. 16 is a view showing an example of a threshold matrix. That is, a threshold matrix, which has a shape (halftone-dot shape) of a Voronoi polygon, and in which each cell corresponds to a dot size recordable by the printer 12, is set. Then, the tone density is expressed by filling (blackening) cells having thresholds less than the tone density value.

The image processor 22 repeats the processes in steps S41 to S43 until it determines in step S44 that the processing of all the Voronoi polygons is complete. FIG. 15 is a view showing an example of a halftone image. FIG. 15 illustrates halftone dots in an enlarged scale to allow easy understanding. However, since there are at least 150 lines, halftone dots are as fine as they cannot be visually confirmed.

[Introduction of Lattice Points]

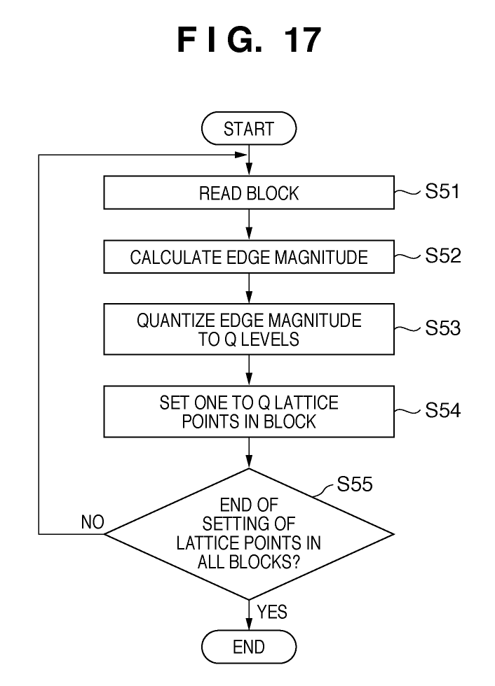

FIG. 17 is a flowchart for explaining introduction of lattice points having the density distribution proportional to the tone density distribution of the smoothed image.

The image processor 22 divides an image into blocks of, for example, L×L pixels, and executes the following processing for each block. The number L of pixels is a value which specifies a halftone-dot ruling of a flat portion (edge-less portion) of an image. For example, when a screen ruling of 150 lines/inch is to be obtained in a 1200-dpi printer, L=8 can be set. Letting B be a band width of an image, a relation B=n·L (n is a natural number) is set.

The image processor 22 reads one block from the smoothed image (S51), and calculates an edge magnitude E in that block (S52). The edge magnitude E may be either an average tone density value of that block or the tone density value of a representative point. Even when either of these values is adopted, there is no large difference since the image has undergone smoothing. When a maximum of Q lattice points are set in the block, the edge magnitude E is quantized to Q levels (S53). For example, when a tone density value has a range from 0 to 255, and quantization is done to 4 levels (Q=4), a quantized edge magnitude Eq is given by:

Eq=round(E/K+1) (4)

for K=256/Q

where round( ) is an integer-conversion function.

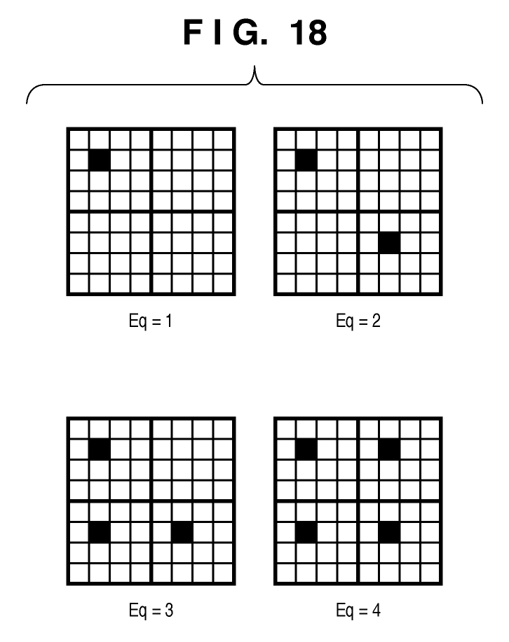

FIG. 18 is a view showing the numbers and positions of lattice points to be introduced to a block according to the edge magnitude Eq, and shows a case of a block of 8×8 pixels.

As shown in FIG. 18, when Eq=1, one lattice point is set at the upper left position of the block, and the position of the lattice point is randomly displaced within a range of one or two pixels by applying slight fluctuation (S54). This is to avoid division by “0”, overflowing, and the like upon calculating a Voronoi polygon, and to set a Voronoi polygon shape which is different from a square as much as possible.

When Eq=2, two lattice points are set at the upper left and lower right positions of the block. When Eq=3, three lattice points are set at the upper left, lower left, and lower right positions of the block. When Eq=4, four lattice points are set at the upper left, lower left, lower right, and upper right positions of the block. After that, these set points undergo slight fluctuation.

Upon calculating the coordinates of lattice points using integer values (for respective pixels), any of the coordinate values of lattice points becomes the same as that of another lattice point, and an error may occur during the calculations. In consideration of such problem, as calculations for giving a displacement (addition of a random number value), those including decimal digits are executed by generating floating-point random number values. Finally, the calculated coordinate values of lattice points are converted into integer values for respective pixels.

The image processor 22 repeats the processes in steps S51 to S54 until it determines in step S55 that processing of all blocks of a band image is complete.

[Centroidal Voronoi Diagram]

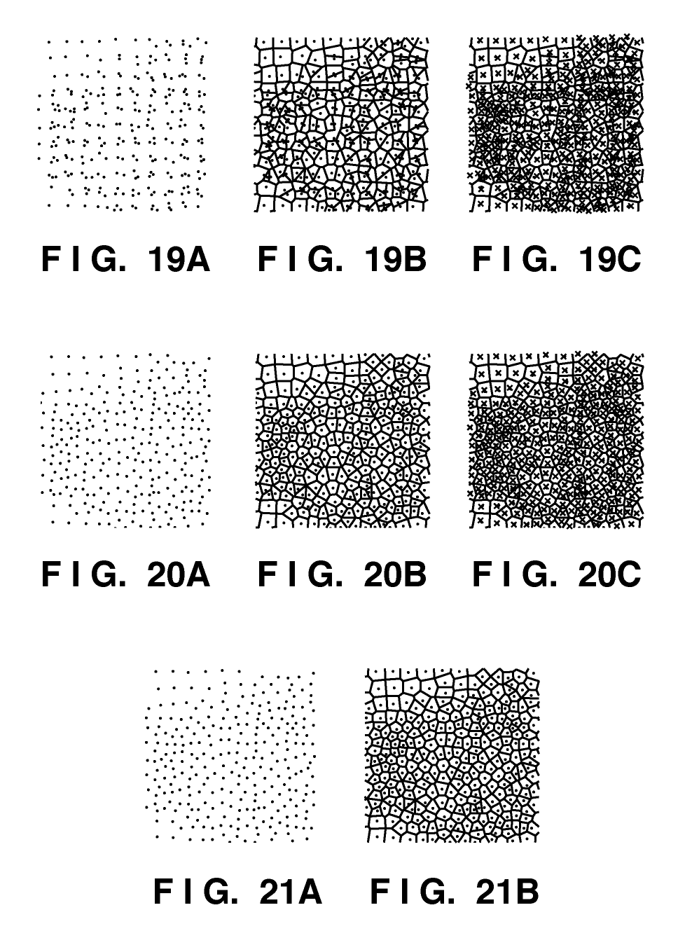

A centroidal Voronoi diagram is obtained by CVT which moves kernel points to the centroids of Voronoi polygons, and applies Voronoi partition again. FIGS. 19A to 21B are views showing a state in which Voronoi partition is executed to have lattice points as kernel points to repeat CVT.

FIGS. 19A to 19C are views showing Voronoi polygons (FIG. 19B) as a result of Voronoi partition to have the lattice points (FIG. 19A, · marks) introduced in step S34 as kernel points, and centroidal points (FIG. 19C, × marks) of the Voronoi polygons. As shown in FIG. 19A, an initial layout of the lattice points is locally uneven in regions where the density is high. As shown in FIG. 19C, local unevenness of the centroidal points of the Voronoi polygons is relaxed compared to the initial lattice points. Therefore, local unevenness can be relaxed when the lattice points are moved to the centroidal points of the Voronoi polygons.

FIGS. 20A to 20C are views showing the CVT result. FIG. 20A shows the lattice points after movement, FIG. 20B shows a centroidal Voronoi diagram, and FIG. 20C shows the centroidal points of the Voronoi polygons in the centroidal Voronoi diagram. FIGS. 21A and 21B are views showing the second CVT result. FIG. 21A shows the lattice points after movement, and FIG. 21B shows a centroidal Voronoi diagram.

As can be seen from comparison of FIGS. 19A, 20A, and 21A, local unevenness of the lattice points is relaxed. As can be seen from reference to FIGS. 19C and 20C, deviations between the kernel points (lattice points) and centroidal points after the CVT are reduced. The number of times of repetition of the CVT may be arbitrary. However, when deviations between the kernel points and centroidal points become equal to or smaller than a predetermined threshold, repetition of the CVT may end.

[Processing of Character Image]

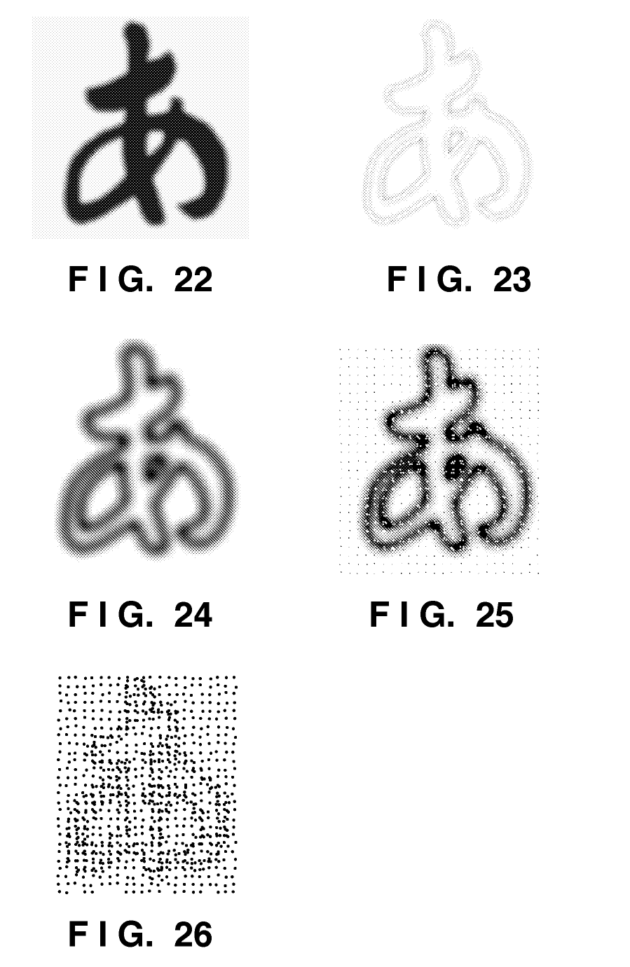

FIG. 22 is a view showing an example of a small character image drawn on a gray background. FIG. 23 shows an edge image of the character image shown in FIG. 22, and a Laplacian filter is used as the edge extraction filter. FIG. 24 shows a smoothed image of the edge image shown in FIG. 23. FIG. 25 shows a state in which lattice points are introduced according to the tone densities of the smoothed image. FIG. 26 shows a state in which the lattice points are extracted from FIG. 25. In this manner, the density of the lattice points corresponding to the edge portion of the character becomes high.

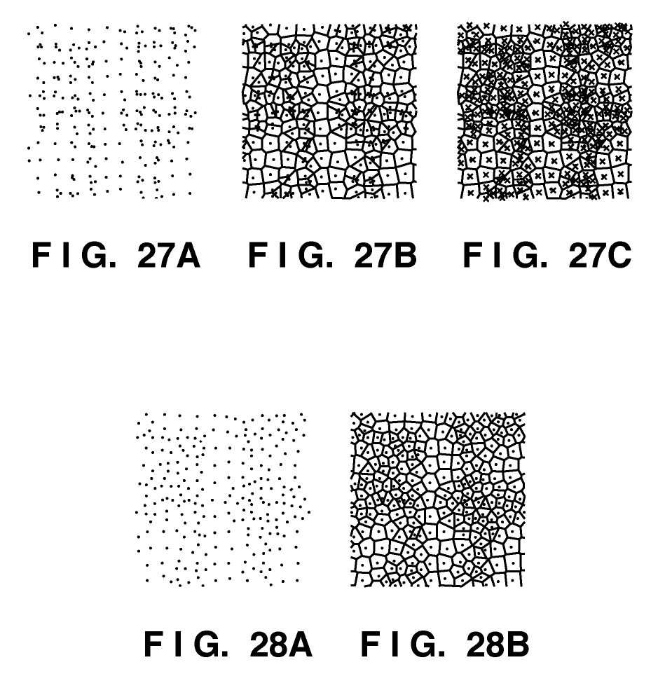

FIGS. 27A to 27C are views showing Voronoi partition having the lattice points in FIG. 26 as kernel points, as partial enlarged views of FIG. 26. FIG. 27A shows some lattice points of FIG. 26, FIG. 27B shows Voronoi polygons, and FIG. 27C shows the centroidal points of the Voronoi polygons. FIGS. 28A and 28B show the second CVT result. FIG. 28A shows the lattice points after movement, and FIG. 28B shows a centroidal Voronoi diagram.

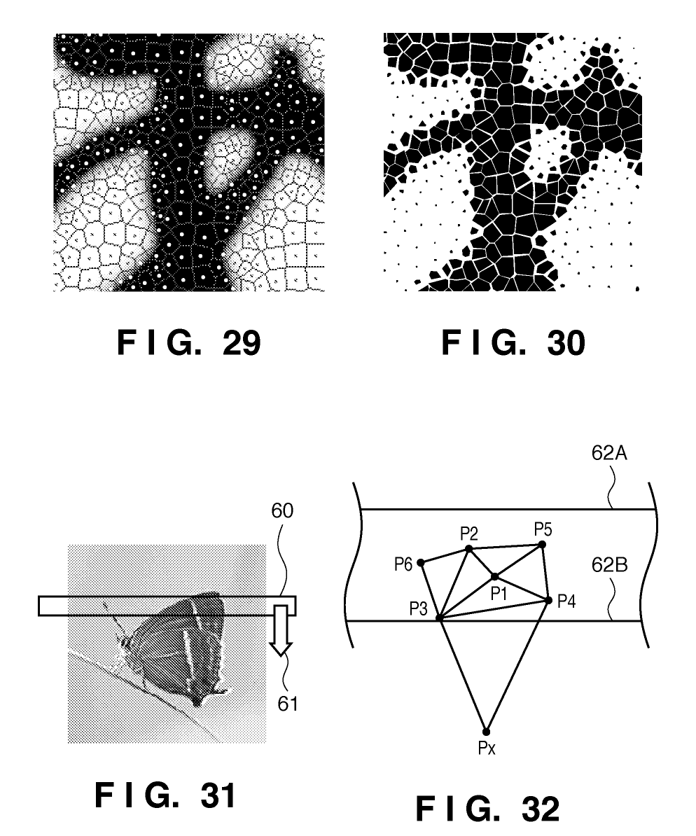

FIG. 29 is a view illustrating the final lattice points and Voronoi polygons to overlap each other, as a partial enlarged view of the character image of FIG. 22. FIG. 30 is a view showing a halftone image obtained by filling the regions of the Voronoi polygons of FIG. 29 in accordance with the tone densities. As can be seen from these figures, the lattice points are laid out at a high density on the edge portion of the character image, and Voronoi polygons of small areas are consequently formed as halftone dot regions. That is, small halftone dots are laid out on an image region having a high spatial frequency like the edge of a character image/line drawing, while relatively large halftone dots are laid out at nearly predetermined intervals on an image region where tones with a smooth change in tone density continuously appear. Therefore, as for a document image formed upon mixing a character image/line drawing, photographic image, and the like, printing that can assure high image quality by reproducing the edge of a text region to be sharp, and tonality of a photographic region to be smooth without zone segmentation can be attained.

[Use of Band Memory]

FIG. 31 is a view for explaining rendering for respective bands. In order to reduce the memory size required for the halftone processing using the VDS, rendering using a band 60 as a unit is effective.

The image processor 22 processes image data for one page by repeating rendering for respective bands while scanning the band 60 in the direction of an arrow 61. In this way, the memory size required for rendering can be suppressed to that for the band width, and a memory size for one page is not required.

However, when rendering for respective bands includes the halftone processing using the VDS, the following problem is posed.

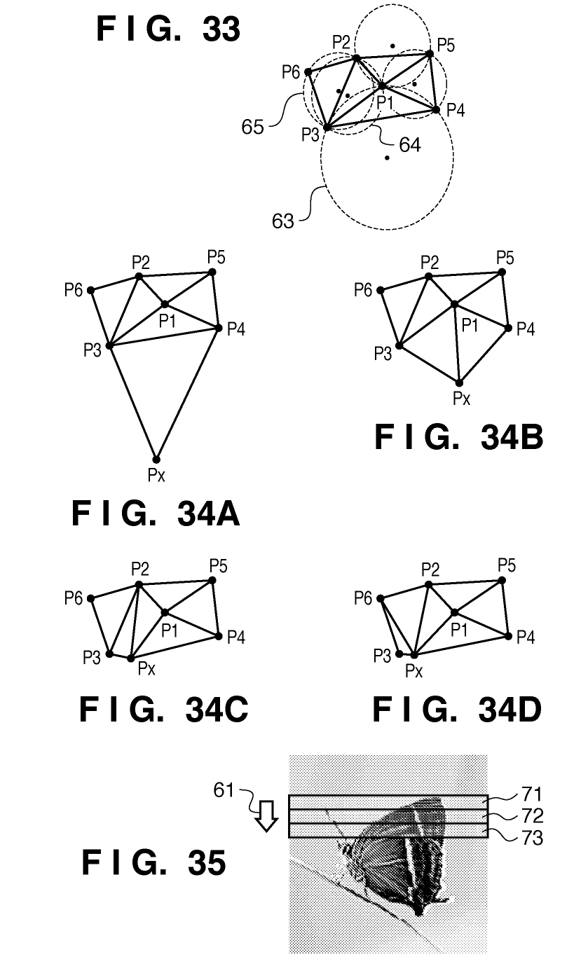

FIG. 32 is a view showing a band image sandwiched between sides 62A and 62B, and assume that lattice points P1 to P6 are set. FIG. 33 is a view for explaining the formation method of Delaunay triangles. A Delaunay triangle is formed based on a rule indicating that its circumscribed circle (circles 63, 64, 65, and the like shown in FIG. 33) does not include any kernel point. Also, a Voronoi polygon is formed based on a rule indicating that its Voronoi sides are perpendicular bisectors of Delaunay sides.

FIGS. 34A to 34D are views showing changes of Delaunay triangles when a lattice point Px is set in the next band image. FIG. 34A shows a case of the positional relationship in which the lattice points P1 to P6 are relatively separated from the lattice point Px. In this case, the Delaunay sides which couple the lattice points P1 to P6 each other remain unchanged, and the Delaunay triangles also remain unchanged. Then, a new Delaunay triangle ΔP3P4Px is formed.

However, when the point Px approaches the side 62B and is located at a position shown in FIG. 34B, a Delaunay triangle ΔP1P3P4 changes to two Delaunay triangles ΔP1P3Px and ΔP1P4Px. When the Delaunay triangles change, the Voronoi polygon changes by necessity. When the point Px further approaches the side 62B and is located at a position shown in FIG. 34C, Delaunay triangles ΔP1P2P3 and ΔP1P3Px change to triangles ΔP2P3Px and ΔP1P2Px. When the point Px further approaches the side 62B and is located at the closest position in FIG. 34D, Delaunay triangles ΔP2P6P3 and ΔP2P3Px change to triangles ΔP6P3Px and ΔP2P6Px.

As described above, when lattice points of a new band are set, the Voronoi polygons of the previous band change. Hence, the Voronoi polygons of the previous band need to be determined again. In other words, it is impossible to independently form Voronoi polygons on each of spatially divided images, and changes of Voronoi polygons of the previous image (band image) need to be permitted.

FIG. 35 is a view for explaining halftone processing for respective bands, which permits changes of Voronoi polygons. Processing for setting Voronoi polygons of two band images 71 and 72 first, and then setting Voronoi polygons of two band images 72 and 73 is repeated. In this way, the influence of the lattice points of the band image 72 can be reflected on the Voronoi polygons of the band image 71, and that of the lattice points of the band image 73 can be reflected on the Voronoi polygons of the band image 72.

On the band memory 21, at least three memory areas need to be set. This is because a high-speed printer such as a laser beam printer requires a buffer memory due to the relationship between the rendering processing including the halftone processing, and the latent image forming speed of a printer engine. Therefore, assuming that reference numerals 71 to 73 in FIG. 35 denote areas of the band memory 21, after band images stored in the areas 72 and 73 are processed, the band image in the area 72 is moved to the area (buffer memory) 71. Then, the band image in the area 73 is moved to the area 72, and a new band image can be read on the region 73. In case of a relatively low-speed printer such as an ink-jet printer, or a printer which can pause printing like a print head of an ink-jet printer, no buffer memories are required.

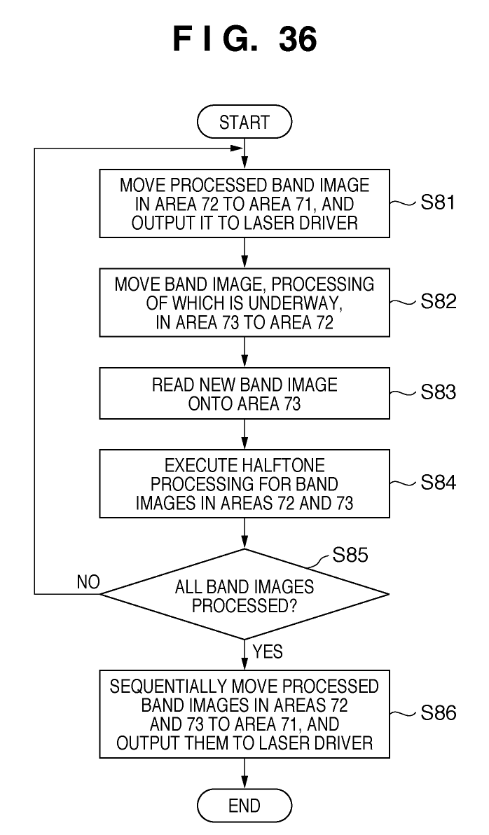

FIG. 36 is a flowchart showing processing of band images.

The image processor 22 moves the processed band image in the area 72 to the area 71, and outputs it to the laser driver 34 (S81). The image processor 22 moves the band image, the processing of which is underway, in the area 73 to the area 72 (S82), and reads a new band image on the area 73 (S83). Subsequently, the image processor 22 executes the halftone processing to the band images in the areas 72 and 73 (S84). The image processor 22 checks if processing of all band images is complete (S85), and repeats steps S81 to S84 until no band image to be processed is found. If no band image to be processed is found, the image processor 22 sequentially moves the processed band images in the areas 72 and 73 to the area 71, and outputs them to the laser driver 34 (S86).

As described above, the halftone processing using the VDS can be executed using the band memory with a small memory size without using any page memory. Normally, a line memory for several ten lines is used as the band memory 21. When image data is compressed by JPEG, it is written in the band memory 21 after decompression. For this reason, it is efficient to configure a band memory having the number of lines as a natural number multiple of 8. If a band memory having 32 lines is used, a memory size amounts to 96 lines by combining the three areas. For example, when the widthwise direction (210 mm) of an A4 size is processed at 600 dpi, the required number of lines is 4,960, and memory cost can be suppressed compared to this.

In this way, a printout with high image quality can be obtained by applying appropriate halftone processing to respective regions without any zone segmentation of a document image formed upon mixing a photographic image, character image/line drawing, and the like. Also, a printout with high image quality can be obtained by applying appropriate halftone processing to respective regions of an image in which a photographic image and character image/line drawing intricately overlap each other, a halftone character image/line drawing, and the like, which cannot undergo zone segmentation.

### Exemplary Embodiments

The present invention can be applied to a system constituted by a plurality of devices (e.g., host computer, interface, reader, printer) or to an apparatus comprising a single device (e.g., copying machine, facsimile machine).

Further, the present invention can provide a storage medium storing program code for performing the above-described processes to a computer system or apparatus (e.g., a personal computer), reading the program code, by a CPU or MPU of the computer system or apparatus, from the storage medium, then executing the program.

In this case, the program code read from the storage medium realizes the functions according to the embodiments.

Further, the storage medium, such as a floppy disk, a hard disk, an optical disk, a magneto-optical disk, CD-ROM, CD-R, a magnetic tape, a non-volatile type memory card, and ROM can be used for providing the program code.

Furthermore, besides above-described functions according to the above embodiments can be realized by executing the program code that is read by a computer, the present invention includes a case where an OS (operating system) or the like working on the computer performs a part or entire processes in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiments.

In a case where the present invention is applied to the aforementioned storage medium, the storage medium stores program code corresponding to the flowcharts described in the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-269531, filed Oct. 16, 2007, which is hereby incorporated by reference herein in its entirety.

What is claimed is:

1. An image processing apparatus comprising:
an input section, arranged to input an image;
a first generator, arranged to generate an edge image of the image;
a smoothing section, arranged to generate a smoothed image by applying smoothing processing to the edge image;
a setting section, arranged to set lattice points having a density distribution according to a tone density distribution of the smoothed image;
a partition section, arranged to partition a predetermined region into polygons each of which surrounds one of the lattice points; and
a second generator, arranged to generate a threshold matrix used to grow a halftone dot surrounded by each polygon.

2. The apparatus according to claim 1, further comprising an adjuster arranged to adjust a tone density of the smoothed image.

3. The apparatus according to claim 1, further comprising an image processor arranged to apply halftone processing to the image input by said input section using the threshold matrix.

4. The apparatus according to claim 1, wherein said setting section sets the lattice points at a high density in a high tone density region of the smoothed image.

5. The apparatus according to claim 1, wherein said partition section repeats the partition to have the centroids of the polygons formed by the partition as kernel points.

6. The apparatus according to claim 1, wherein said second generator generates the threshold matrix by dividing each of the polygons according to a dot size of an image forming apparatus, and sets thresholds to be compared with image data in respective cells of the threshold matrix.

7. The apparatus according to claim 1, wherein said input section sequentially inputs band images obtained by spatially dividing the image, and said first generator, said smoothing section, said setting section, said partition section, and said second generator execute processes for two band images.

8. An image processing method, comprising the steps of:
inputting an image;
generating an edge image of the image;
generating a smoothed image by applying smoothing processing to the edge image;
setting lattice points having a density distribution according to a tone density distribution of the smoothed image;
partitioning a predetermined region into polygons each of which surrounds one of the lattice points; and
generating a threshold matrix used to grow a halftone dot surrounded by each polygon.

9. A computer-readable storage medium storing a computer-executable program for causing a computer to perform an image processing method, the method comprising the steps of:
inputting an image;
generating an edge image of the image;
generating a smoothed image by applying smoothing processing to the edge image;
setting lattice points having a density distribution according to a tone density distribution of the smoothed image;
partitioning a predetermined region into polygons each of which surrounds one of the lattice points; and
generating a threshold matrix used to grow a halftone dot surrounded by each polygon.
